(19) United States
(12) Patent Application Publication
(10) Pub. No.: US 2017/0174513 A1
(43) Pub. Date: Jun. 22, 2017

(54) FUEL CRACKING IN A FLUIDIZED BED SYSTEM

(71) Applicant: Haldor Topsøe A/S, kgs. Lyngby (DK)

(72) Inventor: François-Xavier Chiron, Copenhagen S (DK)

(73) Assignee: Haldor Topsøe A/S, kgs. Lyngby (DK)

(21) Appl. No.: 15/116,084

(22) PCT Filed: Feb. 27, 2015
(86) PCT No.: PCT/EP2015/054185

§ 371 Date: Aug. 2, 2016

(30) Foreign Application Priority Data
Feb. 28, 2014 (DK) PA 2014 70096

(51) Int. Cl. C01B 3/30; C10B 49/22; B01J 8/26

(52) U.S. Cl. CPC C01B 3/30; B01J 8/26; C10B 49/22; C01B 2203/0272; B01J 2208/00017

(57) ABSTRACT

A process for thermally cracking a fuel, said process comprising the steps of—on a solid carrier in a first reaction cracking fuel thereby producing Hydrogen and Carbon species—in a second reaction combusting said Carbon on the solid carrier wherein the first and second reaction is carried out in at least one fluidized bed.

Steam methane reforming (SMR) is by far the most common process to produce H₂ and/or syngas. SMR is a highly endothermic process which requires that additional fuel is burned to maintain the temperature at a desired level in order to compensate for the temperature drop induced by the reaction.

Furthermore the steam addition in the SMR process both adds expenses and can be problematic in areas where water resources are sparse.

Thus alternative processes are needed in order to reduce both economic costs and resource consumption.

In a first aspect of the present invention is provided a system and method which allows H₂ production with minimized water consumption

In a second aspect of the present invention is provided a system and process which has a high methane utilization

In a third aspect of the present invention is provided a system and process which results in product stream comprising H₂ of a high purity

In a fourth aspect of the present invention is provided a system and method having a significantly improved solid handling over known H₂ production techniques.

These and other advantages are achieved by a process for cracking a fuel, said process comprising the steps of
in a first reaction cracking fuel thereby producing Hydrogen and Carbon species on a solid carrier.
in a second reaction combusting said Carbon on the solid carrier
wherein the first and second reactions are carried out in at least one fluidized bed.

In the first reaction, fuel cracking, the endothermic reaction of fuel cracking produces mainly gaseous hydrogen and solid carbon which deposits on the solid carrier. Some other substances may also occur from the cracking depending on e.g. the fuel. The solid carrier covered with carbon species such as coke or/as well as possibility free amorphous carbon particles are subsequently part in the second reaction wherein the Carbon/carbon containing substance is combusted in very hot air to regenerate the solid carrier.

A fuel may be characterized by the formula CₓH_{y}O_{z}. Preferably where Z=0 (e.g. CH₄) allowing the production of a pure H₂ stream.

The carbon species may comprise one or more of CX (various carbon species including carbon with some impurities), free carbon, graphite, amorphous carbon, nanotubes and/or coke etc.

Cracking is in the present context defined as decomposition of a fuel to gaseous species and carbon species.

Using one or more fluidized beds has several advantages over systems with e.g. solid or moving beds. For example the solid gas separation is easier in relation to a fluidized bed and also the general handling of the solid and system is less challenging in fluidized systems. For example in a fluidized bed heat transfer between particles and gas can happen more or less instantly due to the excellent contact. Also in a fluidized bed the heat transfer coefficient can be as high as 500 W m⁻² K⁻¹ and even 1000 W m⁻² K⁻¹ at very high temperatures (e.g. >1000° C.).

Fuel cracking as applied according to the present invention is advantageous over reforming as no catalyst is involved. Therefore the present process is not sensitive to poisons such as sulphur species and metals.

If the first and second reaction is carried out in a first and second fluidized bed the solid carrier can for example circulate between the first and second fluidized bed which may greatly improve solid handling and heat transfer between the two fluidized beds.

Alternatively the first and second fluidized beds are worked sequentially. This can be carried out in a process and system wherein each fluid bed is fed a fuel such as CH₄ and regeneration gas alternatingly. For example a system with two fluidized beds can be operated so that when the first fluidized bed is fed fuel the second fluidized bed is fed regeneration gas. When the solid carrier is spent or regenerated and/or heated to a predetermined temperature the feed to the two fluidized beds are shifted so that regeneration gas is fed to the first fluidized bed and fuel to the second fluidized bed. This sequential operation can also be carried out with more than two fluidized beds e.g. three, four or more beds.

In the sequential operation the heat from the regeneration is used to crack fuel when the gas feed is shifted and thereby the heat from the regeneration can be fully utilized as well as the solid handling is significantly reduced.

In some embodiments fresh solid carrier may be added to one or more of the fluidized beds. For example fresh solid carrier can be added to the fluidized bed in which the cracking reaction is carried out.

Similarly in some embodiments spent solid carrier may be removed from one or more of the fluidized beds. For example spent solid carrier can be removed from the fluidized bed in which the cracking reaction is carried out.

I.e. by the present method and system the solid carrier may continuously or periodically be added and/or removed rendering the solid handling significantly simplified compared to known systems in which the reaction is stopped while all or part of the solid is changed.

A possible operational sequence can be:
Step 1: burn carbon with hot air to reach a high enough temperature
Step 2: inert purge
Step 3: feed dry methane for hydrogen generation down to a certain temperature
Step 4: inert purge

If only one fluidized bed is used the advantage of the heat transfer is still obtained but the production of H₂ is not continuous but limited to the cracking step such as step 3 in the example above.

Continuous operation may be reached by operating two or more fluidized beds in parallel.

IF the solid carrier is cycled between the first and second fluidized bed and the first reaction is carried out in the first fluidized bed and the second reaction is carried out in the second fluidized bed various advantageous embodiments can be achieved. As in the sequential process and system the cyclic process and system is arranged so that the regeneration helps drive the fuel cracking. However, when the two fluidized beds are connected the solid carrier can flow from one fluidized bed to the other in a continuous cycle. In one fluidized bed the fuel e.g. methane is cracked and in the other the solid carrier is regenerated and heated.

In various embodiments the solid carrier is a heat carrier, catalyst and/or a nucleation precursor.

A nucleation precursor may e.g. be carbon particles, or pulverized coal or chars.

A heat carrier can be used to optimize use of the heat from the regeneration process. A heat carrier preferably consists of or comprises one or more materials with a high heat capacity, such as mineral ores, SiC, sand, alumina, silica etc.

If the solid carrier comprises one or more catalytic materials fuel cracking can at least be partially from catalytic cracking.

Preferably the solid carrier is a heat carrier and/or nucleation precursor rendering the process thermal and not catalytic.

A nucleation precursor can comprise or be a material which initiates the growth of carbon generated in the cracking process. In systems where the solid carrier is at least partly a nucleation precursor, the nucleation precursor may be at least partially combusted in the regeneration process. In this case extra nucleation precursor can be added to the fluidized bed where the cracking process is carried out to maintain a sufficient level of nucleation precursor.

For example the solid carrier comprises sand, natural ore, MAl₂O₃, MAl₂O₄, MSiO₂ (wherein M is a metal such as Ni, Cu and/or Fe. Alternatively or additionally other metals such as Co may also be present), Coal and/or Carbon particles. The solid carrier may also comprise dolomite and/or CaO or other materials which can absorb CO₂. The solid carrier can be a single material or a composition. Also the solid carrier can be different type of particles i.e. sand and a nucleation precursor such as carbon.

Preferred carriers may contain acidic sites. Furthermore a high mechanical strength may be advantageous as well as a high melting/softening point may be beneficial due to the elevated temperatures in the reactions. Other preferred properties may include easy separation and/or that no agglomeration of the solid carrier particles occurs during the cracking and/or regeneration process.

I.e. the solid carrier may have the following properties: Allow carbon deposition (e.g. acidic sites), attrition resistant, resistant to high temperature, do not agglomerate, cheap and/or have a high Cp. I.e. the solid carrier should preferably be optimized to withstand the heat of the regeneration process as well as allow the carbon from the cracking process to be “captured” in one or more forms.

The particle size of the solid carrier is preferably between 10-500 μm such as 20-200 μm and/or 50, 100, 200 μm+/−25% or 50%. However for the sequential embodiments even bigger particles may also be used such as up to 800 μm or more.

In combined fluidized beds the cooled solid carrier can be transferred from the first fluidized bed to the second fluidized bed and/or where hot solid carrier is transferred from the second fluidized bed to the first fluidized bed. I.e. the combined fluidized beds allows the solid carrier to circulate whereby the solid handling is improved as well as the heat carrying properties of the solid carrier may be fully used. Furthermore, the combined beds provide a continuous H₂ production.

I.e. according the present process and system fuel e.g. comprising methane can be provided to the first reaction, a product stream comprising H₂ can be withdrawn from the first reaction, a regeneration gas can provided to the second reaction and/or a flue gas can be withdrawn from the second reaction.

The fuel may also be or comprise ethane, flue gas, solid fuels (such as coke, petcoke, residues, biomass), liquid fuel, natural gas and/or even liquid heavy feedstocks. Preferably the fuel is Oxygen free or contains low amounts of Oxygen in order to be able to obtain a pure or at least substantially pure H₂ stream.

Preferably the H₂ stream comprises pure H₂ or close to 100% H₂. E.g. 80-100% H₂, such as 90-99% H₂. In some embodiments depending on e.g. fuel the H₂ content may be up 99% or up to 95% H₂, such as 90-95% H₂. Preferably the H₂ content is above 80%, more preferably above 90% or even above 95%.

For example fuel comprising methane, ethane, natural gas and/or even liquid heavy feedstocks is provided to the first reaction in the first fluidized bed, a product stream comprising H₂ is withdrawn from the first reaction in the first fluidized bed, a regeneration gas is provided to the second reaction in the second fluidized bed and/or a flue gas is withdrawn from the second reaction in the second fluidized bed.

In some embodiments heat from the second reaction is transferred through a barrier separating the first and second fluidized bed in which cases the heat generated in the regeneration reaction can be carried to the cracking reaction via the solid carrier as well as through the separating barrier. As the heat is carried over by the solid carrier as well as through the separating barrier the utilization of the generated heat can be more effective. This may also e.g. allow the solid carrier to be of a material less efficient for carrying the heat from the regeneration to the cracking step/bed thereby providing less restrictions on the selection of the material(s) for the solid carrier.

Feed temperature: fuel and/or regeneration gas can be preheated by means of a feed effluent heat exchanger. The feed temperature may depend on the feed. The feed temperature may be as high as 800-900° C. or even higher. However the temperature may also be lower e.g. from 500° C.

Temperature drop across the first fluidized bed with the fuel reaction may for example be from 100-500° C., such as 200, 300, or 400° C.

For example the process can be initiated by the steps:
Raising the temperature by burning fuel in the regeneration reactor thereby heating the solid
Shifting to burning air+C in order to maintain the temperature

Also provided is a fluidized bed system comprising a first fluidized bed containing at least a solid carrier and a second fluidized bed containing at least a solid carrier, wherein the system is arranged to be operated in a manner where the solid carrier in the first and/or second fluidized bed alternatingly is used to crack a fuel and is regenerated in a combustion process.

I.e. in various embodiments are provided a fluidized bed system arranged to carry out a process wherein fuel is cracked by heat from a solid carrier and where the solid carrier is regenerated in a process which also provides heat to the solid carrier and thereby to the cracking process.

In some embodiments one or more fluidized beds are arranged to be worked sequentially i.e. where in one fluidized bed first cracking is carried out and thereafter regeneration is carried out in the same fluidized bed. For example two fluidized beds are worked so that in the first bed regeneration is carried out and in the second cracking is carried out where after the feed is changed so that in the first cracking is carried out using the heat from the regeneration while in the second bed regeneration is carried out.

Alternatively the system is arranged so that the first and second fluidized beds are connected so that solid carrier can be circulated between the two beds.

The process feed fed to the first cracking reaction preferably comprises CₓH_{y}O_{z} (preferably where Z=0 such as CH₄) and/or higher hydrocarbons or even liquid feed stock and/or heavy petroleum fractions. Preferably the feed is Oxygen free or substantially Oxygen free.

The process feed is preferably preheated to a temperature of 500-1000° C., Such as 600-800° C. The process feed may by heated by means of feed-effluent heat exchanger, burners, boiler etc.

The regeneration gas provided to the regeneration process preferably comprises pure Oxygen and/or a mixture containing or comprising Air, enriched air, steam, CO₂. The regeneration gas oxidizes C to CO₂ and/or CO.

The temperature of the regeneration gas is preferably 500 1000° C.

The process of cracking splits hydrocarbons into Carbon and H₂. E.g. methane is cracked by CH₄═C+2 H₂ΔrH1200° C.=67.7 kJ/mol. Similarly C₂H₆=2C+3H₂ i.e. in general CₓH_{y}=xC+y/2H₂

If oxygen is present in the fuel feed the reverse shift: CO₂+H₂═CO+H₂O also occurs.

The regeneration is given bv: C+O₂->CO₂, C+H₂O->CO+H₂, C+CO₂->2CO

Additional methane may be fed to the second reaction if needed to assist combustion.

From a thermodynamic point of view, methane cracking (as well as cracking of hydrocarbon feeds in general) is favoured at high temperature and low pressure. This means that fuel cracking in a fluidized bed as described herein can be carried out at relatively low pressure. I.e. 0.1-1.5 bar.

For example the pressure in the fluidized bed in which the fuel cracking is carried out may be approximately 1 bar, 5 bar or 10 bar, such as between 1-15 bar.

For example the pressure in the fluidized bed in which the regeneration process is carried out may be approximately 1 bar, 5 bar or 10 bar, such as between 1-15 bar.

If the pressure in the first and second fluidized beds are comparable or e.g. substantially the same compression stages may be avoided.

The fluidization velocity in cracking bed may be up to e.g. 2000 cm/s, such as 0.1-500 cm/s depending on the fluidizing regime.

The fluidization velocity in regeneration bed be up to e.g. 2000 cm/s, such as 0.1-500 cm/s depending on the fluidizing regime.

A critical aspect of the process may be to provide enough energy via the solid carrier particles in order to crack a fuel e.g. methane at high temperature. High temperature may be in the range of 800-2000° C., such as 900° C. or 1200° C. However, the present system and method provides ideal embodiments to achieve this by heating the carrier in the regeneration process and maintain/transferring this heat to the cracking process/bed.

The system may comprise a first vessel containing at least the first fluidized bed and a second vessel containing at least the second fluidized bed.

The system may further comprise various means for providing and/or regulating one or more gas flows. Said one or more gas flows preferably comprising a fuel e.g. methane and/or a regeneration gas.

The system can also have means for withdrawing and/or regulating a flue gas and/or a product stream comprising H₂.

I.e. the system can be arranged with various means for providing and removing process gas (fuel/regeneration gas) and products (flue gas/H₂) from the fluidized beds. Said means for providing and/or removing process gas (fuel/regeneration gas) and products (flue gas/H₂) may include various carriers such as pipes, compressors, ejectors, valves and/or filters etc.

In embodiments where the solid carrier is circulating, the system can comprise means for circulating the solid carrier between the first and second vessel. The means may comprise passages such as passages or piping leading spent solid carrier from the top of the cracking bed to the bottom of the regeneration bed, and/or passages leading “regenerated” solid carrier from the top of the regeneration bed to the bottom of the cracking bed. The fluidization of the beds makes the solid carrier flow from the bottom to the top of each fluidized bed.

The fluidization may cause solid carrier to float i.e. carried over in the product gases H2 and/or flue gas and thus the system may preferably comprise means for retrieving solid carrier from the product and/or flue gas stream. Such means may be e.g. be one or more cyclones and/or various filters.

In systems arranged so that the second vessel and first vessel shares at least one wall the heat generated in the regeneration process (e.g. in the second vessel) may be carried to the cracking process (e.g. in the first vessel) through the shared wall/barrier.

A shared wall can be realized by an arrangement where the first and the second vessel are arranged side by side. If the second vessel at least partly encloses the first vessel or vice versa a larger part of the walls may be shared and the heat transfer here through may be optimized.

Preferably the system is arranged to carry out the process described herein i.e. the system comprises the means to enable that the process is carried out as well as the process may comprise steps for working the system.

The present process and system can be used in relation to other process and systems. For example a water gas shift reaction can be carried out downstream the present process. Upstream the present process various pre-treatments and reactions of process feed can be carried out to achieve a desired feed composition for the cracking reaction.

It has been shown by the applicant that the fuel utilization by use of the present process and system is excellent. If needed part of the fuel e.g. up to 10% can be used for heating purposes.

In classic steam methane reforming, a significant part of the fuel is burnt together with air outside the reformer tubes to counterbalance the reforming reaction endothermicity. In the proposed invention, little fuel or even no fuel is burnt separately. The energy is supplied by simply the carbon species that are carried out the re-heater vessel.

CH4+H2O═CO+3H2 (1)

CO+H2O═CO2+H2 (2)

CH4+2O2=CO2+2H2O (3)

CH4=C+2H2 (4)

C+O2=CO2 (5)

Steam reforming stays better in term of Hydrogen produced per mole of methane fed, because of the water being a reactant in reaction (1) and (2).

Furthermore, fluidization has a clear advantage over other technology in solid handling and heat transfer performances.

Thus by the present process is provided a way to provide sufficient heat to the methane cracking process while handling large quantities of solid material by using the fluidized bed in sequence or with circulating solid carrier.

### FIGURES

Details of the process and system are further described below with reference to the accompanying drawings. The figures are exemplary and are not to be construed as limiting to the invention.

FIG. 1 shows a system 1 having two fluidized beds i.e. a first bed 2 and second bed 3 arranged to be worked sequentially. The first and second bed is arranged in a first and second vessel respectively.

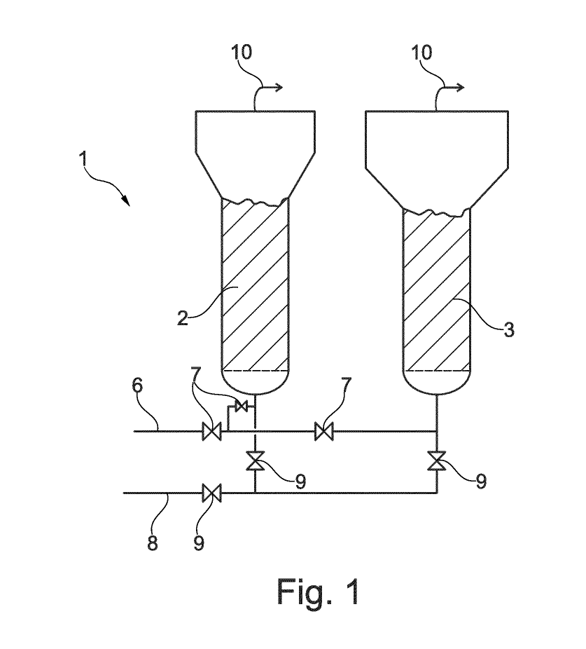

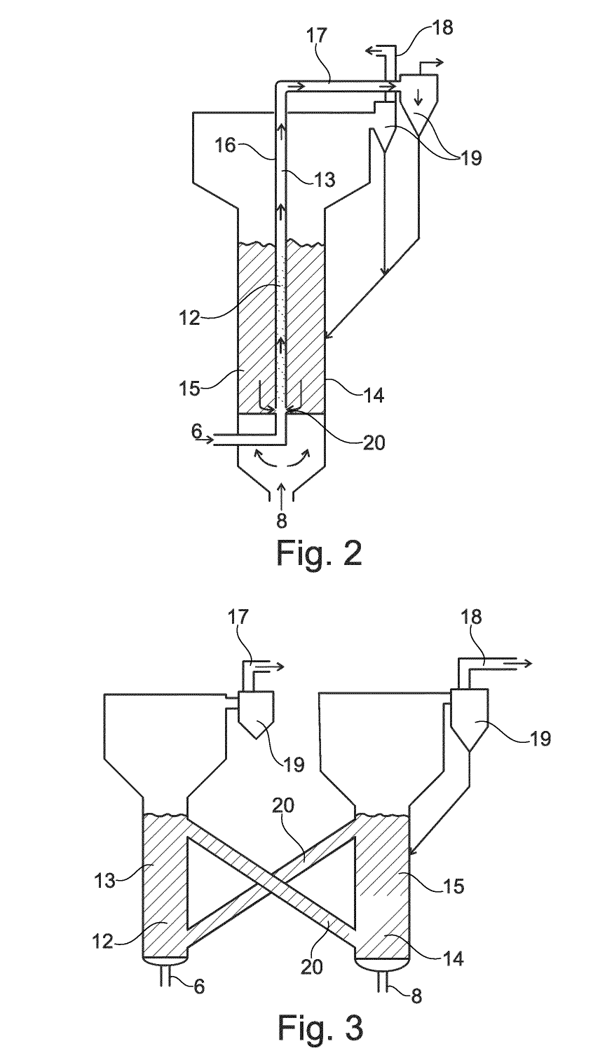

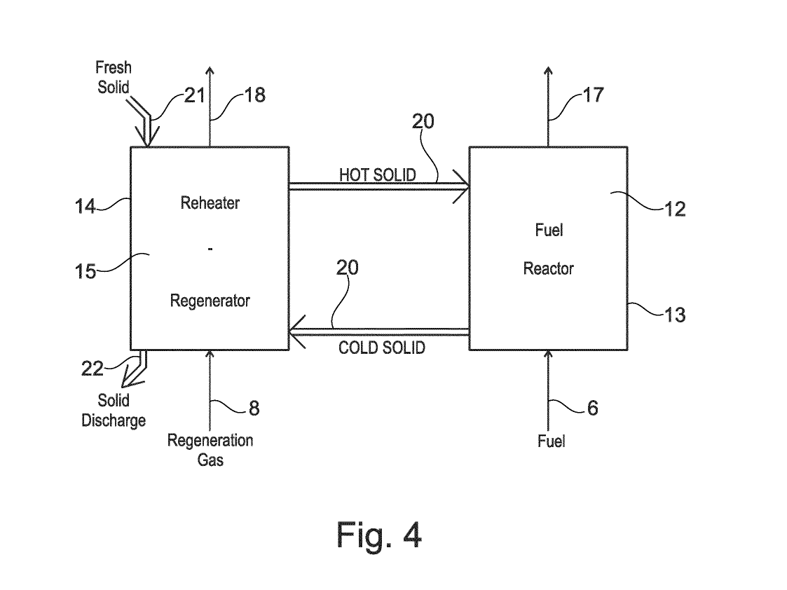

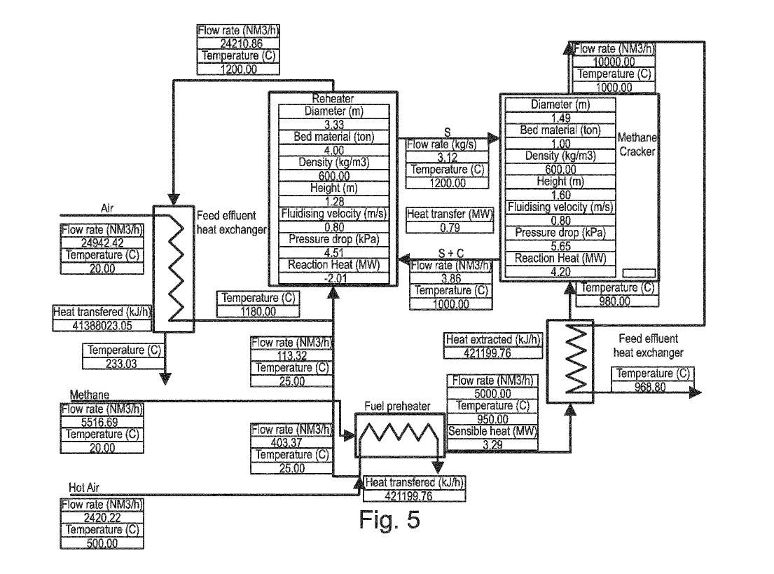

A fuel supply 6 is arranged to supply fuel to the first and second fluidized bed. The fuel supply is regulated by valves 7 whereby fuel can be administered and regulated to the first and/or the second bed. A regeneration gas supply 8 is arranged to supply regeneration gas to the first and second fluidized bed. The regeneration gas supply is regulated by valves 9 whereby regeneration gas can be administered to the first and/or the second bed. From each fluidized bed a product line 10 leads reaction products away from the bed/vessel.

The present sequential system can be operated by regulating the valves to allow fuel such as CH₄ to one bed, e.g. the first while allowing regeneration gas to the other bed (e.g. second bed). This way fuel will be cracked in the first bed while solid carrier is regenerated in the second bed. When the solid carrier in the first bed is spent and/or the solid carrier in the second bed is regenerated the system can be switched so that fuel will be cracked in the second bed while solid carrier is regenerated in the first bed.

By using two or more beds in this sequential manner it is possible to have a continuous or at least substantially continuous flow of H₂ from the system. If needed, the first and/or second bed can be flushed by an inert in between the step of cracking and regeneration in the beds.

FIG. 2 Shows a system wherein two fluidized beds are arranged to share a wall thereby allowing heat to transfer from the regeneration bed to the reaction bed through the shared wall.

More precisely the first fluidized bed 12 wherein the cracking process is carried out is arranged in a first tubular vessel 13. Around the first vessel is arranged a second vessel 14 containing the second fluidized bed 15 wherein the regeneration takes place. The first and second vessel shares a wall 16. I.e. the system is based on an inner tubular vessel 13 and an outer concentric vessel 14 arranged so that the heat from the regeneration process is transferred optimally to the cracking process.

The system further comprises means in form of pipes 17 for leading product from the cracking reaction in the first vessel 13 as well as means in form of pipes 18 leading flue gas from the regeneration reaction in the second vessel 14. In connection with the means for removing product gas and flue gas are means for retrieving solid carrier from a product and/or flue gas stream here in form of cyclones 19. From the cyclones the retrieved solid carrier is returned to at least one of the fluidized beds such as to the second vessel i.e. for regeneration.

The solid carrier is cycled from the second vessel to the first vessel through means for circulating the solid carrier between the first and second vessel here in form of openings 20. The flow from the second to the first vessel can e.g. be driven by the pressure difference in the two vessels. In the present setup the speed of gas flow in the first vessel may be larger than in the second vessel depending on the specific diameters etc.

FIG. 3 shows an alternative embodiment of a system with two connected vessels, a first 13 and a second vessel 14, the vessels containing a first fluidized bed 12 and a second fluidized bed 15 respectively. In the present embodiment the first 13 and second vessel 14 are arranged as separate vessels connected by means 20 for circulating the solid carrier between the first and second vessel. The means for circulating the solid carrier between the first and second vessel 20 allows spent solid carrier to migrate from the top of the first fluidized bed 12 to the lower part of the second fluidized bed 15. Similarly the means for circulating the solid carrier between the first and second vessel 20 allows regenerated solid carrier to migrate from the top of the second fluidized bed 15 to the lower part of the first fluidized bed 12.

As for the two previous examples the embodiment in FIG. 3 also comprises means for supplying fuel 6 and means for supplying regeneration gas 8. The systems also comprises means for removing product gas 17 and flue gas 18 from the fluidized beds as well as cyclones 19 arranged to retrieve solid carrier from the gas stream exiting the fluidized beds/vessel and allowing the retrieved solid carrier to be returned to the first and/or second fluidized bed.

FIG. 4 shows a schematic representation of the present process and system.

The flow shows how cooled solid is transferred from the first fluidized bed 12 to the second fluidized 15 via means 20. In the first fluidized bed fuel is processed in a cracking reaction and the product consisting of or comprising H₂ is taken out via means 17. Fuel is provided to the first fluidized bed via fuel supply means 6. In the second fluidized bed 15 the solid is regenerated and at the same time heated. From the second fluidized bed the heated solid is transferred to the first fluidized bed via means 20. Regeneration gas is added via means 8 and flue gas is let away via an outlet 18.

Fresh solid may be added to the system e.g. via a feed 21 to the second fluidized bed as well as it is possible to remove spent carrier via a solid discharge 22.

### EXAMPLE: HEAT AND MASS BALANCE

A general H&M balance has been carried out in Excel using the HSC Chemistry Add-on.

Assumptions
5000 Nm3/h of methane are being cracked
Pressure is set as atmospheric
Methane is also used when extra heat is needed (through combustion)

Air/methane ratio=1.2
Solid is fed to the re-heater at 1000° C. and leaves the reactor at 1200° C.
The heat carrier is supposed to be alumina (Cp=1.268 kJ/kg at 1000° C.)
Carbon is supposed amorphous (Cp=1.93 kJ/kg at 1000° C.)
Reverse shift is not considered as methane cracking is believed to be more critical

Results are summarized in FIG. 5.

1. A process for thermally cracking a fuel, said process comprising the steps of
on a solid carrier in a first reaction cracking fuel thereby producing Hydrogen and Carbon species
in a second reaction combusting said Carbon on the solid carrier
wherein the first and second reaction is carried out in at least one fluidized bed.

2. A process according to claim 1 wherein the first and second reaction is carried out in a first and second fluidized bed.

3. A process according to claim 1, wherein the fuel is CₓH_{y}O_{z} such as methane.

4. A process according to claim 1, wherein the carbon species comprises free carbon, graphite, amorphous carbon, nanotubes and/or coke.

5. A process according to claim 1, wherein the first and second fluidized bed are worked sequentially.

6. A process according to claim 1, wherein the solid carrier is cycled between the first and second fluidized bed, preferably the first reaction is carried out in the first fluidized bed and the second reaction is carried out in the second fluidized bed.

7. A process according to claim 1, wherein the solid carrier is a heat carrier and/or a nucleation precursor.

8. A process according to claim 1, wherein the solid carrier comprises sand, natural ore, MAl₂O₃, MSiO₂, dolomite, CaO, Coal and/or Carbon particles.

9. A process according to claim 1, wherein cooled solid carrier is transferred from the first fluidized bed to the second fluidized bed and/or where hot solid carrier is transferred from the second fluidized bed to the first fluidized bed.

10. A process according to claim 1, wherein a fuel is provided to the first reaction, a product stream comprising H₂ is withdrawn from the first reaction, a regeneration gas is provided to the second reaction and/or a flue gas is withdrawn from the second reaction.

11. A process according to claim 1, wherein a fuel is provided to the first reaction in the first fluidized bed, a product stream comprising H₂ is withdrawn from the first reaction in the first fluidized bed, a regeneration gas is provided to the second reaction in the second fluidized bed and/or a flue gas is withdrawn from the second reaction in the second fluidized bed.

12. A process according to claim 1, wherein heat from the second reaction is transferred through a barrier separating the first and second fluidized bed.

13. A fluidized bed system comprising a first fluidized bed containing at least a solid carrier and a second fluidized bed containing at least a solid carrier, wherein the system is arranged to be operated in a manner where the solid carrier in the first and/or second fluidized bed alternatingly is used to crack a fuel and is regenerated in a combustion process.

14. A fluidized bed system according to claim 13 comprising a first vessel containing at least the first fluidized bed and a second vessel containing at least the second fluidized bed.

15. A fluidized bed system according to claim 13 comprising means for providing and/or regulating a gas flow comprising a fuel and or/a gas flow comprising a regeneration gas.

16. A fluidized bed system according to claim 13 comprising means for withdrawing and/or regulating a flue gas and/or a product stream comprising H₂.

17. A fluidized bed system according to claim 13 wherein the second vessel and first vessel shares at least one wall.

18. A fluidized bed system according to claim 13 wherein the second vessel at least partly encloses the first vessel.

19. A fluidized bed system according to claim 13 comprising means for circulating the solid carrier between the first and second vessel and/or vice versa.

20. A fluidized bed system according to claim 13 comprising means for retrieving solid carrier from a product and/or flue gas stream.

21. A fluidised bed system according to claim 13 arranged to carry out a process comprising the steps of:
on a solid carrier in a first reaction, cracking fuel thereby producing Hydrogen and Carbon species
in a second reaction, combusting said Carbon on the solid carrier
wherein the first and second reaction is carried out in at least one fluidized bed.

22. A H₂ product provided by the process according to claim 1.
